(19) United States
(12) Patent Application Publication
(10) Pub. No.: US 2024/0360710 A1
(43) Pub. Date: Oct. 31, 2024

(54) BARRICADE TO PREVENT ACCESS THROUGH A DOOR AND A METHOD OF USING THE SAME

(71) Applicant: Victor Julian Weir, Chesterfield, VA (US)

(72) Inventor: Victor Julian Weir, Chesterfield, VA (US)

(21) Appl. No.: 18/308,380

(22) Filed: Apr. 27, 2023

(51) Int. Cl. E05C 19/00

(52) U.S. Cl. CPC E05C 19/005; E05C 19/004

(57) ABSTRACT

A right-angled triangle barricade for a door it is not directly connected to. The right-angle barricade is pivotably mounted to a supporting surface, such as a wall or ceiling, adjacent to the door to be barricaded. The right-angle barricade is pivotably movable from an inactive orientation, where its profile is flush against the supporting surface and not in the swing path of the door, to an active orientation where its profile is normal to the door and forces imparted on the door are transferred to be normal against the supporting surface.

### BACKGROUND OF THE INVENTION

The present invention relates to security devices for doors and more particularly, to a barricade to prevent access through an inward-swinging door and a method of using the same.

During a home invasion or active shooter event in a school or office building it may be necessary to barricade a door. Often doors may be barricaded by moving furniture into place or using other mechanical devices designed for barricading the inward-swinging door. Moving furniture and like during a panic-filled moment is a recipe for disaster.

Devices like door chains, locking devices (as found in hotel rooms), straight bars or other devices that mount onto a door jamb are inherently weak. Their strength depends on how strongly they are anchored to the door jamb and/or the door itself, and as a result they can be breached by applying a focused force sufficient to overpower the door jamb, whereby the device could be blown off the door jamb.

A need exists for a barricade to prevent access through an inward-swinging door and a method of using the same.

### SUMMARY OF THE INVENTION

The present invention avoids the inherent weakness of mounting to the jamb or to the jamb and door by instead mounting onto an adjacent wall and does not use the door jamb at all for support. Thus, any attempt to blow through the door will only serve to anchor the barricade more securely in its mounting surface, thereby the present invention is an improvement over the prior art.

The present invention embodies a device that barricades a door by easily swinging into place when needed, thereby avoiding the need to move heavy furniture into place to develop a sturdy barricade.

In one aspect of the present invention, a barricade for a door includes a right angle arrangement of members pivotably connected to a supporting surface beyond a door jamb of the door, wherein the supporting surface is substantially perpendicular to the door, wherein the barricade is movable between an inactive orientation substantially flush with the supporting surface and an active orientation substantially normal to the door in a closed condition.

In another aspect of the present invention, the barricade for the door further includes wherein the barricade is not in mechanical communication with the door in the closed condition in the inactive and active orientations, wherein the supporting surface is a wall, wherein in the active orientation the barricade extends from the wall to at least an opposing edge of the door in the closed condition, where in the active orientation the barricade extends adjacent to a midportion of the door in the closed condition, where in the active orientation the barricade extends adjacent to a floor supporting the door; further including a tension member interconnects the wall and the barricade, wherein the supporting surface is a ceiling.

In yet another aspect of the present invention a barricade for a door, includes the following: a right-angle arrangement of members pivotably connected to the door so as to be movable between an inactive orientation substantially flush with the door and an active orientation substantially normal to both the door in a closed condition and a floor supporting the door; one or more anchor pins for removably connecting the barricade in the active orientation to the floor.

These and other features, aspects and advantages of the present invention will become better understood with reference to the following drawings, description, and claims.

### BRIEF DESCRIPTION OF THE DRAWINGS

FIG. 1 is a perspective view of an exemplary embodiment of the present invention in an inactive orientation.

FIG. 2 is a perspective view of an exemplary embodiment of the present invention in an active orientation.

FIG. 3 is a perspective view of an exemplary embodiment of the present invention in the inactive orientation.

FIG. 4 is a perspective view of an exemplary embodiment of the present invention in the active orientation.

FIG. 5 is a perspective view of an exemplary embodiment of the present invention in the inactive orientation.

FIG. 6 is a perspective view of an exemplary embodiment of the present invention in the active orientation.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a right-angle barricade for a door it is not directly connected to. The right-angle barricade is pivotably mounted to a supporting surface, such as a wall or ceiling, adjacent to the door to be barricaded. The right-angle barricade is pivotably movable from an inactive orientation, where its profile is flush against the supporting surface and not in the swing path of the door, to an active orientation where its profile is normal to the door and forces imparted on the door are transferred to be normal against the supporting surface.

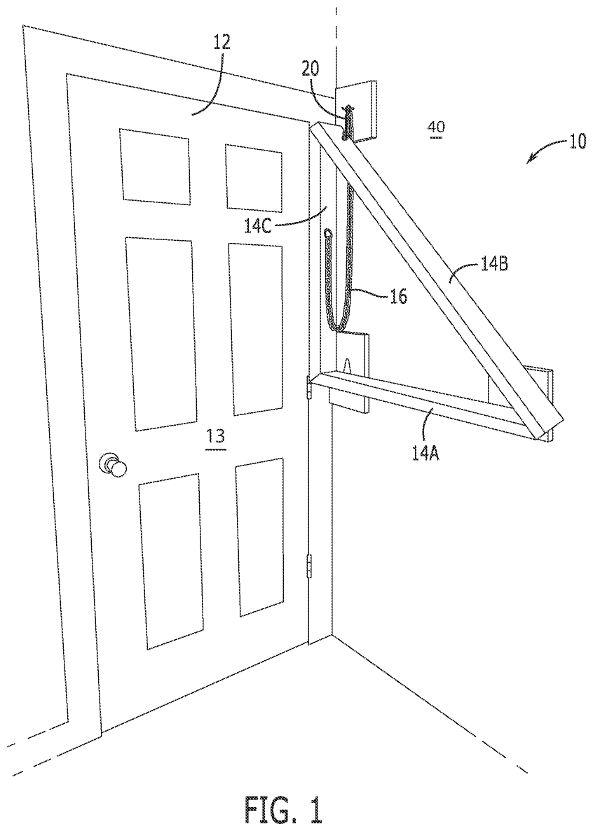

Referring to FIGS. 1 through 6, the present invention may include a barricade 10 for space having an inward-swinging door 12. The barricade 10 provides a first leg 14A, a second leg 14B, and a third leg 14C joined at their ends to form a right-angled triangle (right-triangle). The first and second legs 14A and 14C may be approximately perpendicular to each other, forming a right angle, and the third leg 14B (hypotenuse) being opposite to the right angle. A supporting surface 40 adjacent to the door 12 may have a plurality of connectors 42, up to one for each vertex of the barricade 10 for moving the barricade 10 between an inactive orientation and an active orientation.

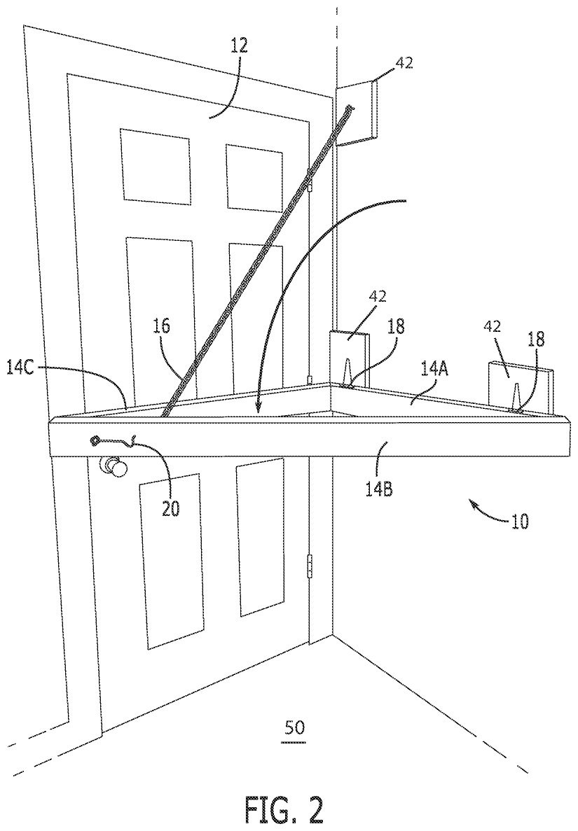

In a first embodiment of the present invention a novel system may include an arrangement of a plurality of connectors 42 along a wall 40. Two of the connectors 42 are equally spaced apart from a floor 50, thereby defining a plane parallel with said floor 50, with the third connector 42 vertically and linearly offset from one of the two connectors 42 that is adjacent to the door 12, as illustrated in FIGS. 1 and 2. The connectors 42 may be attached to studs or reinforcement of the wall 40. Each of two lower connectors 42 may have a pivot point 18, such as a hinge or the like, about which the barricade 10 moves from an inactive orientation parallel and adjacent to the wall 40 and an active orientation transverse and adjacent to a midportion of the door 12. The third, highest connector 42 may provide a flexible, strong tension member 16 (such as a chain, cord, nylon rope, or the like) that is connected to the second leg 14C (adjacent to the door 12 in the active orientation), so as to vertically supports the barricade 10 in the active orientation. The vertex of the second and third legs 14C and 14B may provide a locking element 20, such as a hook, that removably connects the barricade 10 to the third, highest connector 42 in the inactive condition.

In the active condition, the adjacent second leg 14C may extend the entire width of the door 12 along its midsection 13 (typically where the door is thickest) near the handle of the door. The combination of the middle portion of the door 12 and extending the width of the door 12 (thereby minimizing the leverage an assailant can impart on the barricade 10) along with the strength inherent in a right triangle keeps the assailant at bay. The force that the assailant urges on the door 12 is transferred against the support wall 40 (as opposed to the door jamb). When the upright triangle is a right-triangle, the resulting force vectors are efficiently transferred to the support wall 40. In a variant of the first embodiment, barricade 10 can be attached so that the triangular profile of the barricade 10 is adjacent to or near the floor.

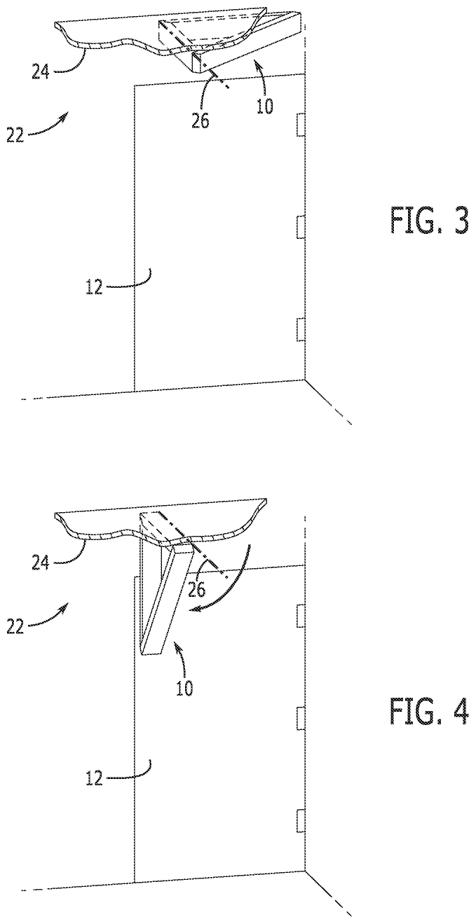

Referring to FIGS. 3 and 4, in a second embodiment 22, the barricade 10 is supported to the ceiling 24, which in turn provides the three connectors 42 so that the pivot points 26 enable the barricade 10 to move between the inactive orientation with its profile adjacent the ceiling and an active orientation wherein the first or third leg 14A or 14B overlaps along a top of the door, with the barricade 10 normal to the door 12 for resisting inward pushing.

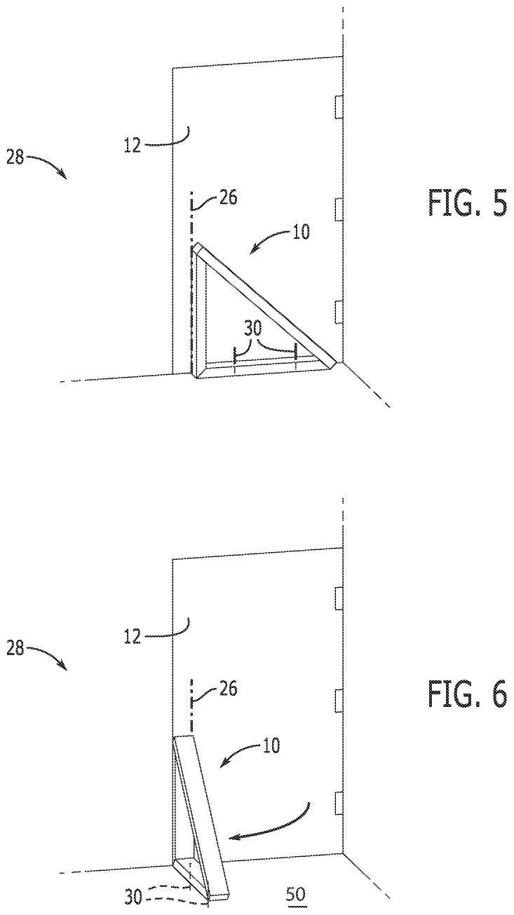

Referring to FIGS. 5 and 6, in a third embodiment 28 of the present invention the barricade 10 may be flush with a lower portion of the door 12 in the inactive orientation, wherein the pivot points 26 pivotably connect the, say first leg 14A to the door, so that it may be moved to its active orientation by pivoting it so as to be normal relative to the door. Anchor pins 30 may be provided along the, say, second leg 14C to fix the second leg 14C to the floor.

The present invention can be built by arranging three 2×4 (or 1×3) wooden beams into a right-angled triangle (opposite, adjacent and hypotenuse arms) or arranging perforated telescoping metal bars into a right-angled triangle, or other sufficiently strong members. For packaging, two hinges will be required so the device can be folded and then assembled when unpackaged. When built from perforated metal telescoping bars the present invention can be adjustable to fit any door or opening. It is arranged by nailing or screwing the wood beams together. If metal is used it can be welded together in some areas.

A method of installation can include the following. Once the door is measured from jamb to jamb, the other lengths can be set using the appropriate proportions. Hinges may be mounted onto the medium length bar/leg so that they are aligned with the studs of the adjacent wall. One hook should be installed onto a stud close to the door and the other installed onto the short length bar. The chain may be mounted onto the hooks and the locking hook is mounted onto the longest bar/leg. The locking hook allows the device to be stored out of the way when not in use. Arrangements of hooks and chains in the other embodiments can be conveniently chosen to achieve the aim of storing the barricade when not in use.

An additional element that could be added would be an electrical motor and an electrical switch added to allow the motor to rotate the device into place or out of the way when not in use. The motor could be wired to be controlled from a switch mounted in a convenient location so that by flipping the switch the device could be moved into place.

In one variation, the device 10 can be also made more simply by using the hypotenuse arm 14B of the triangle alone and securing it to the adjacent wall by using a hinge with a receptacle for the base of the bar. A second receptacle can be provided at the door to act as a wedge for the bar. With a telescoping bar, the length can be adjusted to fit any door. If not in use it can be stored against the wall, so it is out of the way. This may also be installed on the floor with the base of the device attached to the baseboard.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the present invention.

What is claimed is:

1. A barricade for a door, comprising:
a right-angled triangle arrangement of members pivotably connected to a supporting surface beyond a door jamb of the door, wherein the supporting surface is substantially perpendicular to the door, wherein the barricade is movable between an inactive orientation substantially flush with the supporting surface and an active orientation substantially normal to the door in a closed condition.

2. The barricade for the door of claim 1, wherein the barricade is not in mechanical communication with the door in the closed condition in the inactive and active orientations.

3. The barricade for the door of claim 2, wherein the supporting surface is a wall.

4. The barricade for the door of claim 3, where in the active orientation the barricade extends from the wall to at least an opposing edge of the door in the closed condition.

5. The barricade for the door of claim 4, where in the active orientation the barricade extends adjacent to a midportion of the door in the closed condition.

6. The barricade for the door of claim 4, where in the active orientation the barricade extends adjacent to a floor supporting the door.

7. The barricade for the door of claim 4, further comprising a tension member interconnects the wall and the barricade.

8. The barricade for the door of claim 2, wherein the supporting surface is a ceiling.

9. A barricade for a door, comprising:
a right-angled triangle arrangement of members pivotably connected to the door so as to be movable between an inactive orientation substantially flush with the door and an active orientation substantially normal to both the door in a closed condition and a floor supporting the door.

10. The barricade for the door of claim 9, further comprising one or more anchor pins for removably connecting the barricade in the active orientation to the floor.
